(19) United States
(12) Patent Application Publication
(10) Pub. No.: US 2024/0401623 A1
(43) Pub. Date: Dec. 5, 2024

(54) CONNECTING TOOL AND CONNECTING STRUCTURE

(71) Applicant: YKK Corporation, Tokyo (JP)

(72) Inventors: Madoka Nanbu, Toyama (JP); Yohei Shimizu, Tokyo (JP)

(21) Appl. No.: 18/672,668

(22) Filed: May 23, 2024

(30) Foreign Application Priority Data
May 30, 2023 (JP) 2023-088574

(51) Int. Cl. F16B 12/10

(52) U.S. Cl. CPC F16B 12/10

(57) ABSTRACT

A connecting tool includes: a plug member; and a socket member. The plug member includes at least one pair of elastic clips, and the pair of elastic clips each include a claw portion. The socket member includes at least one pair of openings. The claw portion has a claw surface on a claw portion engagement side configured to be engaged in an insertion direction and a release side inclined surface configured to be engaged in a release slide direction, and the opening has a first step portion configured to be engaged with the claw surface on the claw portion engagement side and second step portions configured to be engaged with the release side inclined surface.

### CROSS-REFERENCE TO RELATED APPLICATIONS

This application is based on and claims priority under 35 USC § 119 from Japanese Patent Application No. 2023-088574 filed on May 30, 2023, the contents of which are incorporated herein by reference.

### TECHNICAL FIELD

The present invention relates to a connecting tool used for connecting two components, the connecting tool including a plug member attached to the component on one side and a socket member attached to the component on another side, and a connecting structure for connecting members using the connecting tool.

### BACKGROUND ART

When components of wooden assembled furniture such as a shelf for furniture and a table are connected to each other, or when resin components or metal components such as automobile interior components are connected to each other, a connecting structure using concave-convex engagement between a plug member and a socket member is widely used. For example, a connecting tool as illustrated in FIG. 16 is used as a structure for connecting wall components of cabinet described in Patent Literature 1. In a connecting tool in the related art, a plug-side member 201 is fixed to a component 230 on one side, a socket-side member 202 is fixed to a component 240 on another side, and the plug-side member 201 and the socket-side member 202 are engaged with each other, thereby fixing the two components 230 and 240. The plug-side member 201 includes a locking groove 203, the socket-side member 202 includes an elastically deformable clip 204, and the locking groove 203 is engaged with the elastically deformable clip 204 to connect the two components 230 and 240.

In the connecting structure described in Patent Literature 1, the plug-side member 201 and the socket-side member 202 are connected to each other by pushing the plug-side member 201 into the socket-side member 202 in a connection direction (direction from the bottom to the top in a paper of FIG. 16), and the connection between the plug-side member 201 and the socket-side member 202 is released by making the plug-side member 201 slide with respect to the socket-side member 202 in a direction (direction from the back to the front in the paper of FIG. 16) orthogonal to the connection direction. With such a connecting structure as described in Patent Literature 1, it is convenient because the connection can be easily released and reassembled even when the component is erroneously assembled or when it is desired to replace the component.
Patent Literature 1: JPH08-150027A

However, the connecting structure described in Patent Literature 1 still has room for improvement in order to make the periphery of a connection portion compact in that it is necessary to provide a space 206 for the elastically deformable clip 204 provided in the socket-side member 202 to be deformed between the elastically deformable clip 204 and a wall portion 205 on a socket storage side. In addition, the connecting structure described in Patent Literature 1 has room for improvement in that positioning in the direction orthogonal to the connection direction (direction from the back side to the front side in the paper of FIG. 16) is not performed.

### SUMMARY OF INVENTION

An object of the present invention is to provide a more compact and high-performance connecting tool capable of easily connecting and disconnecting components, and a connecting structure for connecting members using the connecting tool.

A connecting tool according to one aspect of the present disclosure includes: a plug member; and a socket member. The plug member includes at least one pair of elastic clips, and the pair of elastic clips each include a claw portion facing an outside of the plug member, and rear surfaces of the elastic clips, which are back sides of surfaces on which the claw portions are present, face inward. The socket member includes at least one pair of openings configured to be engaged with the elastic clips. When a direction in which the plug member is to be inserted into the socket member is defined as an insertion direction and a direction orthogonal to the insertion direction is defined as a release slide direction, the claw portion has a claw surface on a claw portion engagement side configured to be engaged in the insertion direction and a release side inclined surface configured to be engaged in the release slide direction, and the opening has a first step portion configured to be engaged with the claw surface on the claw portion engagement side and second step portions configured to be engaged with the release side inclined surface. By operating the plug member in the release slide direction with respect to the socket member from a state in which the plug member is engaged with the socket member, an engagement between the release side inclined surface and the second step portions is released, and the plug member is separated from the socket member by further moving the plug member in the insertion direction with respect to the socket member from this state.

In some cases, in the state in which the plug member is engaged with the socket member, the claw surface on the claw portion engagement side, which is a surface of the claw portion facing the first step portion, is a surface inclined with respect to an engaged surface of the first step portion.

In some cases, the plug member includes a base plate portion to which the elastic clips are to be attached, and a surface of the base plate portion opposite to a surface on which the elastic clips are extended is an insertion-side front surface.

In some cases, attachment portions are provided on both sides of the base plate portion of the plug member via insertion-side side surface portions, respectively.

In some cases, a partition wall is provided inside the socket member, and the partition wall is a portion in contact with the insertion-side side surface portion of the plug member in an initial operation stage of inserting the plug member into the socket member.

In some cases, the openings of the socket member each have an inverted U-shaped space, one side portion of the inverted U-shaped space is the first step portion, two side portions on both sides of the one side portion on which the first step portion is provided are the second step portions, and a side facing the side on which the first step portion is provided is opened.

In some cases, one side of the claw portion, which is opposite to another side on which the release side inclined surface is provided, is a vertical surface.

In some cases, the plug member includes two or more sets of the elastic clips, and a wall portion is provided between the elastic clips.

A connecting structure according to one aspect of the present disclosure is a connecting structure using the connecting tool according to any one as described above. A first connecting main body is provided with a counterbore hole to which the plug member is to be attached, a second connecting main body is provided with a counterbore hole to which the socket member is to be attached, and the plug member and the socket member are configured to be engaged to connect the first connecting main body and the second connecting main body.

In some cases, a flat surface of the first connecting main body to which the plug member is to be attached, and a surface of an attachment portion of the plug member, are substantially the same surfaces. A flat surface of the second connecting main body to which the socket member is to be attached, and a surface when the plug member is attached, are substantially the same surface.

In some cases, one side opposite to another side on which the release side inclined surface of the claw portion of the plug member is provided is a vertical surface, and in the first connecting main body, the vertical surface of the plug member is disposed on a gravity-receiving side in a gravity-acting direction, and the release side inclined surface of the plug member is disposed on a side opposite to the gravity-receiving side.

### BRIEF DESCRIPTION OF DRAWINGS

FIG. 1 is a perspective view of a plug member.

FIG. 2 is a plan view of the plug member.

FIG. 3 is a front view of the plug member.

FIG. 4 is a side view of the plug member.

FIG. 5 is a perspective view of a socket member.

FIG. 6 is a plan view of the socket member.

FIG. 7 is a front view of the socket member.

FIG. 8 is a side view of the socket member.

FIG. 9 is a diagram illustrating a state in which the plug member is attached to a first connecting main body for use (example of a connecting structure for T-shaped connection).

FIG. 10 is a diagram illustrating a state in which the socket member is attached to a second connecting main body for use (example of a connecting structure for T-shaped connection).

FIG. 11 is a diagram illustrating a state in which the plug member and the socket member are combined.

FIG. 12 is a diagram illustrating a state taken along a cross section B-B in FIG. 11.

FIG. 13 is a diagram illustrating a state in which the plug member is attached to the first connecting main body for use (example of a connecting structure for surface connection).

FIG. 14 is a diagram illustrating a state in which the socket member is attached to the second connecting main body for use (example of a connecting structure for surface connection).

FIG. 15 is a diagram illustrating another embodiment of a connecting tool.

FIG. 16 is a diagram illustrating a connecting tool in the related art.

### DESCRIPTION OF EMBODIMENTS

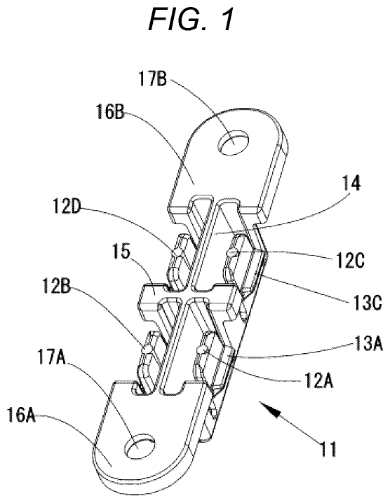

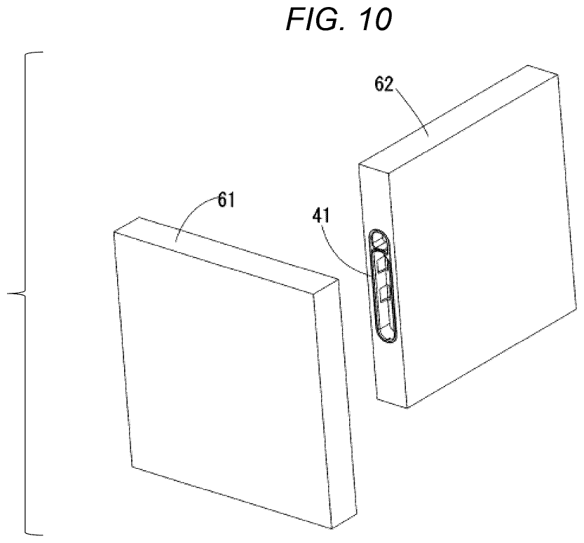

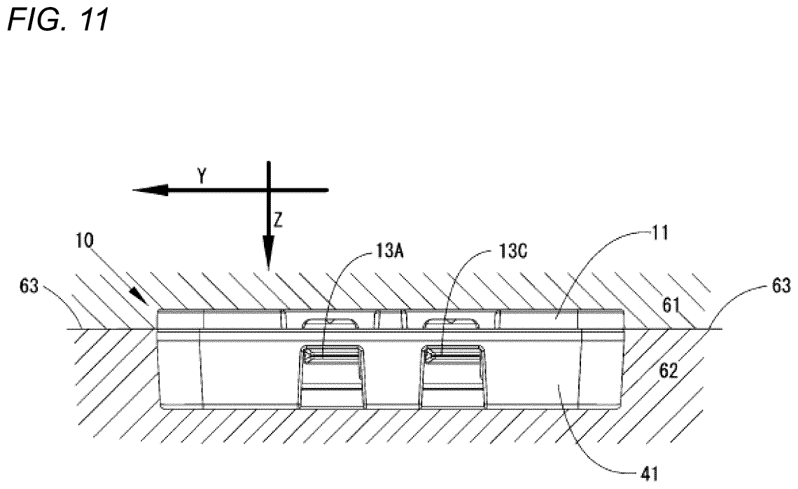

Hereinafter, embodiments of the present invention will be described with reference to the drawings. A connecting tool 10 according to the present invention functions by combining a plug member 11 and a socket member 41, FIGS. 1 to 4 are diagrams illustrating the plug member 11 according to a first embodiment of the present invention, FIGS. 5 to 8 are diagrams illustrating the socket member 41 according to the first embodiment of the present invention, and FIG. 11 illustrates a state in which the plug member 11 and the socket member 41 are combined. In addition, the plug member 11 and the socket member 41 of the connecting tool 10 according to the present invention are attached to components to be originally connected (such as plates for furniture or automobile interior components) for use, and the components to be originally connected (such as the plates for furniture or the automobile interior components) are referred to as a “first connecting main body 61” and a “second connecting main body 62” (see FIGS. 9, 10, 13, and 14 in the drawings). Furthermore, in the description of the present specification, a direction in which the plug member 11 is inserted into the socket member 41 is defined as an insertion direction (see an arrow Z in FIG. 11), and a direction that is orthogonal to the insertion direction and in which an engagement piece (claw portion 13) extends in a longitudinal direction (longitudinal direction of the longitudinal direction and a lateral direction of the plug member 11 and the socket member 41) is defined as a release slide direction (see an arrow Y in FIG. 11). In the drawings, for ease of viewing the drawings and for convenience of description, a ridge line of a corner portion of a component is partially omitted.

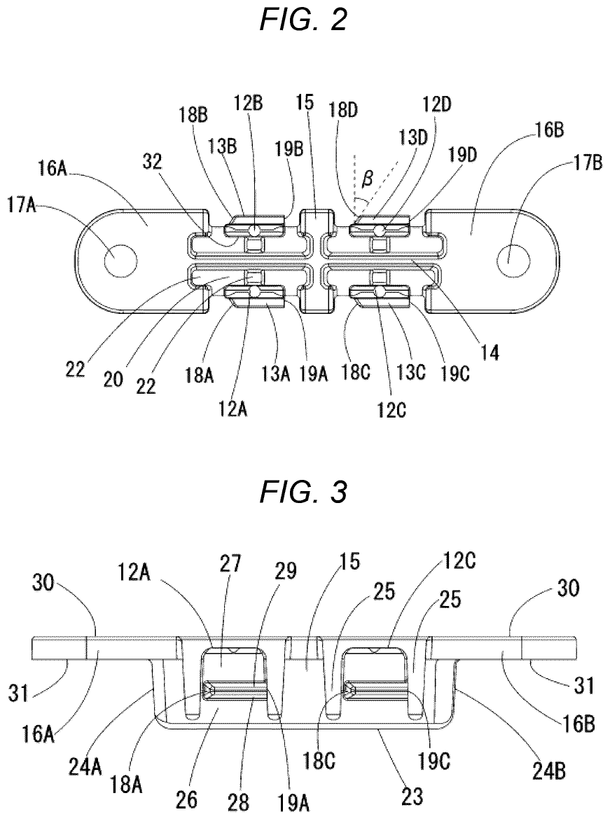

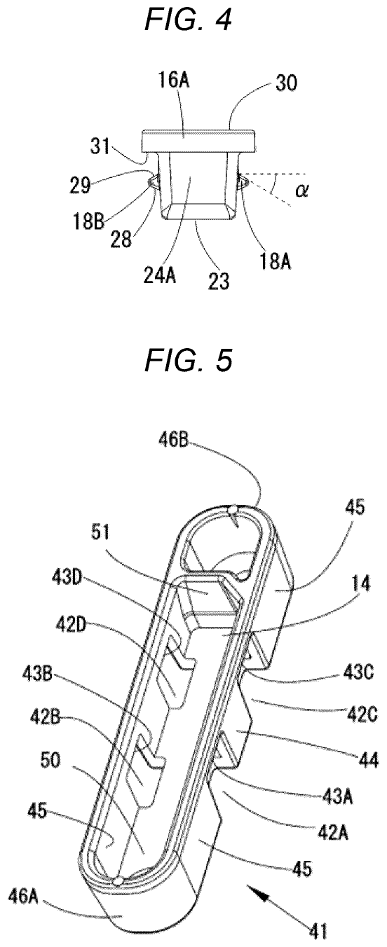

First, the plug member 11 will be described in detail. FIG. 1 is a perspective view of the plug member 11, FIG. 2 is a plan view of the plug member 11, FIG. 3 is a front view of the plug member 11, and FIG. 4 is a side view of the plug member 11. In the first embodiment, the plug member 11 includes four elastic clips 12A, 12B, 12C, and 12D. The elastic clips 12A, 12B, 12C, and 12D include respective claw portions 13A, 13B, 13C, and 13D facing the outside of the plug member 11. The elastic clips 12A to 12D are engaged with openings 42A to 42D (see FIGS. 5 and 7) of the socket member 41 to be described later. The elastic clip 12A and the elastic clip 12B include the respective claw portion 13A and claw portion 13B extending toward the outside of the plug member 11, and rear surfaces 32 in which no claw portion 13A and claw portion 13B is present are disposed in a positional relation of facing inward (positional relation of being back-aligned) so as to sandwich the first wall portion 14 therebetween. Such a pair of elastic clips 12A, 12B and another pair of elastic clips 12C, 12D are arranged side by side in such a positional relation so as to sandwich a second wall portion 15 therebetween. The first wall portion 14 and the second wall portion 15 have a function of ensuring rigidity of the plug member 11, and are integrally connected in a cross shape at a substantially central position of the plug member 11. (In the description of the present specification, for descriptions common to the four elastic clips 12A, 12B, 12C, and 12D, only one representative elastic clip 12 may be numbered in the drawings or the like.)

Attachment portions 16A and 16B are provided on both sides of each of the elastic clips 12A to 12D of the plug member 11. As illustrated in FIG. 3, the attachment portions 16A and 16B are made of plate-shaped members having a thickness smaller than the entire thickness of the clip member 11, and attachment holes 17A and 17B are provided at appropriate positions of the plate-shaped members. The plug member 11 is attached to the first connecting main body 61, which is the component to be originally connected (such as the plate for furniture or the automobile interior component), for use by passing attachment components such as screws through the attachment holes 17A and 17B (also see the “first connecting main body 61” and the “second connecting main body 62” illustrated in FIGS. 9 and 10 to be described later). The plug member 11 may be attached to the first connecting main body 61 by adhesion or the like instead of screws, and in this case, it is not necessary to provide the attachment holes 17A and 17B.

As illustrated in FIG. 2, the attachment portions 16A and 16B are integrally connected to the first wall portion 14, thereby further improving the rigidity of the plug member 11. As illustrated in FIGS. 3 and 4, the attachment portions 16A and 16B are integrally connected to a base plate portion 20 via insertion-side side surface portions 24A and 24B of the plug member 11, and the base plate portion 20 is also integrally connected to the first wall portion 14 and the second wall portion 15. A surface of the base plate portion 20 on a side opposite to a side on which the elastic clip 12 is disposed serves as an insertion-side front surface 23, and serves as a surface on a side that is first inserted into the socket member 41 during the engagement operation. With this configuration, an insertion side of the plug member 11 can be smoothly inserted since there is no other protrusion portion that is likely to be caught except for the claw portion 13, and a component having an engagement function (portion corresponding to the elastic clip 12 of the present embodiment) is less likely to be broken. The base plate portion 20 has a thickened reinforcing rib 21 between the elastic clip 12 and the first wall portion 14. With such a mechanical structure, the plug member 11 has excellent overall rigidity. In the integral connecting structure of the attachment portions 16A and 16B and the insertion-side side surface portions 24A and 24B, as illustrated in FIG. 2, cutout recess portions 22 are provided. From the viewpoint of strength or rigidity alone, it is considered that a solid configuration may be adopted as a whole without providing the cutout recess portion 22, but when the plug member 11 is manufactured by injection molding of a synthetic resin, there is a failure that the resin contracts in a resin cooling process and forms a recess portion called a sink mark, and thus in the present embodiment, the cutout recess portion 22 is intentionally provided.

As described above, in order to ensure the overall rigidity of the plug member 11 and to ensure a deformation amount of the elastic clip 12, notches 25 are provided on both left and right sides of each of the elastic clips 12A, 12B, 12C, and 12D (see FIG. 3). In the elastic clip 12, the claw portion 13 is disposed in a substantially central portion, and the claw portion 13 and the base plate portion 20 are connected to each other by an elastic clip base portion 26. The elastic clip base portion 26 is designed to become gradually wider and thicker from the claw portion 13 toward the base plate portion 20, and the notches 25 are designed to extend to both side portions of the elastic clip base portion 26. The elastic clip base portion 26 can ensure a balance between mechanical structural strength and elastic deformation due to deflection of the elastic clip 12. On the other hand, an elastic clip tip portion 27 is provided on a side opposite to the elastic clip base portion 26 of the elastic clip 12 so as to extend from the claw portion 13. The elastic clip tip portion 27 comes into contact with an inner surface of the socket member 41 and receives an elastic force of the elastic clip 12 when the plug member 11 is connected to the socket member 41.

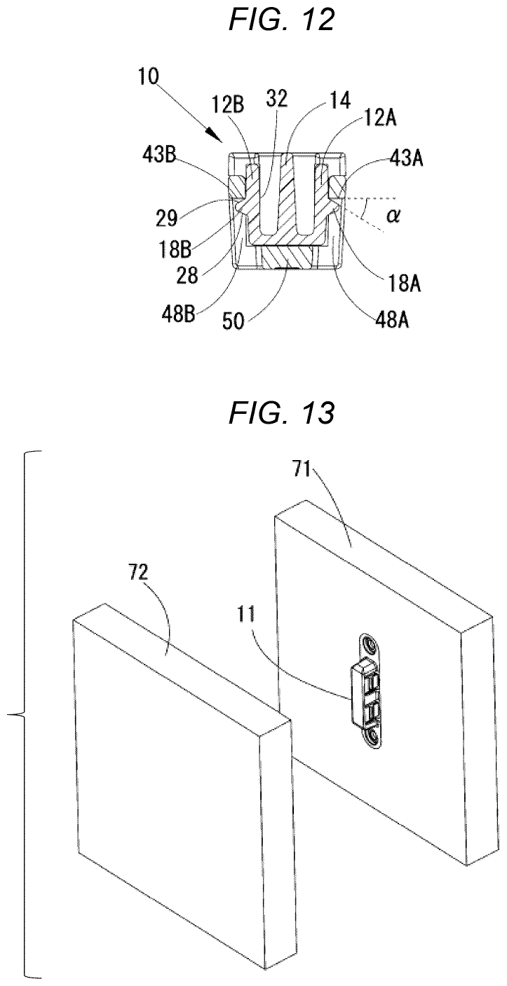

Next, a detailed structure of the claw portion 13 will be described. As illustrated in FIG. 4, the claw portion 13 includes a claw surface 28 on a claw portion insertion side inclined downward toward a front side in the insertion direction into a socket, and a claw surface 29 on a claw portion engagement side inclined downward toward a rear side (release direction side) in the insertion direction into the socket. The claw surfaces 29 on the claw portion engagement side of the claw portions 13A to 13D are engaged with first step portions 43A to 43D (see FIGS. 5 and 7) of the openings 42A to 42D of the socket member 41 to be described later. The claw surface 28 on the claw portion insertion side is inclined so as to gradually protrude from a flat surface of the elastic clip base portion 26, the claw surface 28 on the claw portion insertion side and the claw surface 29 on the claw portion engagement side are smoothly connected to each other by a curved surface, and the claw surface 29 on the claw portion engagement side is connected so as to be gradually inclined downward toward a flat surface of the elastic clip tip portion 27. The claw surface 28 on the claw portion insertion side has a function of allowing the claw portion 13 to smoothly enter an engaged portion (first step portions 43A to 43D to be described later) on a socket member 41 side in a process of inserting the plug member 11 into the socket member 41, and on the other hand, the claw surface 29 on the claw portion engagement side is engaged with the engaged portion (first step portions 43A to 43D) on the socket member 41 side. According to an engagement technique using a general claw, from the viewpoint of improving an engagement strength, it is common for the claw surface 29 on the claw portion engagement side to be a surface orthogonal to the flat surface of the elastic clip tip portion 27 rather than being gradually inclined downward toward the flat surface of the elastic clip tip portion 27. However, in the embodiment of the present invention, an inclined surface is intentionally used. The reason for this is to absorb an attachment error that occurs when the plug member 11 and the socket member 41 are respectively attached to the “first connecting main body 61” and the “second connecting main body 62”, which are components to be originally connected (such as the plates for furniture or the automobile interior components), and the details thereof will be described later. An inclination angle α (see FIG. 4) of the claw surface 29 on the claw portion engagement side is not necessarily provided as long as no attachment error occurs, but when the inclination angle α is provided, the inclination angle α is preferably 5 degrees to 45 degrees and more preferably 10 degrees to 30 degrees, with respect to an engaged flat surface (in the embodiment, a surface of the first step portion 43. See FIG. 12.). The inclination of the claw surface 29 on the claw portion engagement side may be partially a curved surface, and a degree of the curved surface in this case may be a curved surface in a range in which an engagement strength is equivalent to an engagement strength obtained when replacing with the above-described preferred inclination angle α of the flat surface.

In the connecting tool 10 of the present invention, a special design is made to the claw portion 13 so that the engagement between the plug member 11 and the socket member 41 can be released by making the plug member 11 slide in the direction orthogonal to the insertion direction of the plug member 11 into the socket member 41. As illustrated in FIG. 2, one ends of the claw portions 13A, 13B, 13C, and 13D are release side inclined surfaces 18A, 18B, 18C, and 18D, and the other ends of the claw portions 13A, 13B, 13C, and 13D are vertical surfaces 19A, 19B, 19C, and 19D. The release side inclined surfaces 18A to 18D and the vertical surfaces 19A to 19D of the claw portions 13A to 13D are engaged with second step portions 48A to 48D (see FIG. 7) of the openings 42A to 42D of the socket member 41 to be described later. When the socket member 41 is slid with respect to the plug member 11 in a certain direction of the release side inclined surfaces 18A to 18D with an operation force of a certain amount or more, the release side inclined surfaces 18A to 18D climb over the second step portions 48A to 48D of the openings 42A to 42D, and the engagement is released. Conversely, even when the socket member 41 is slid with respect to the plug member 11 in a certain direction of the vertical surfaces 19A to 19D, the vertical surfaces 19A to 19D do not climb over the second step portions 48A to 48D of the openings 42A to 42D. An inclination angle β (see FIG. 2) of each of the release side inclined surfaces 18A to 18D is preferably an inclined flat surface of 10 degrees to 60 degrees and more preferably 20 degrees to 40 degrees with respect to an engaged surface (surfaces of the second step portions 48A to 48D in the embodiment). The release side inclined surfaces 18A to 18D may be partially curved surfaces, and a degree of the curved surface in this case may be a curved surface in a range in which an engagement strength is equivalent to an engagement strength obtained when replacing with the above-described preferred inclination angle β of the flat surface.

The plug member 11 as described above can be manufactured as an integrally molded product by, for example, resin injection, and a shape of each portion of a mold used in the manufacture is designed so that the plug member 11 can be manufactured only by the mold divided into two upper and lower portions without using a slide core. For example, it is also possible to further improve the rigidity of the entire component by connecting the attachment portion 16A and the attachment portion 16B by a bar-shaped member without making a space above the tip portion 27 of each of the elastic clips 12A to 12D an open space, but in this case, a slide core is required for a mold used for manufacturing, and thus in the present embodiment, no structure is provided in an upper space of the elastic clips 12A and 12B on an elastic clip tip portion 27 side, and an open space is provided. The structure of the embodiment of the present invention is also advantageous in terms of manufacture in that the shape of each portion is designed so that the plug member 11 can be manufactured only by the mold divided into two upper and lower portions.

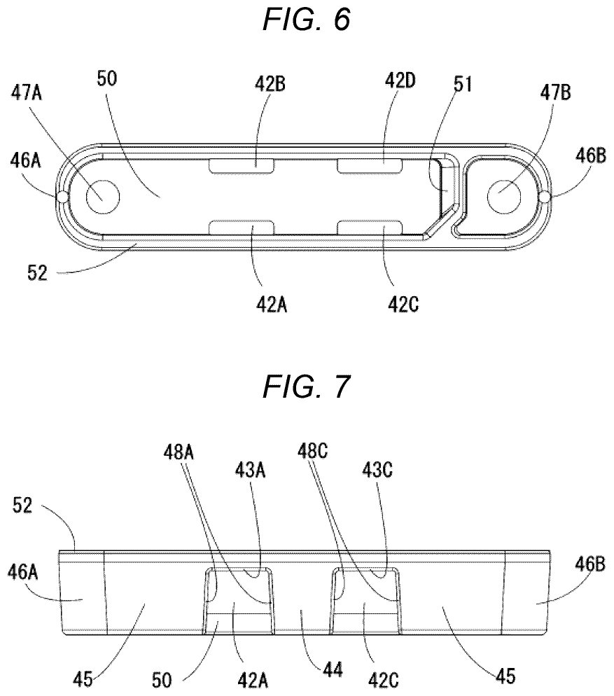

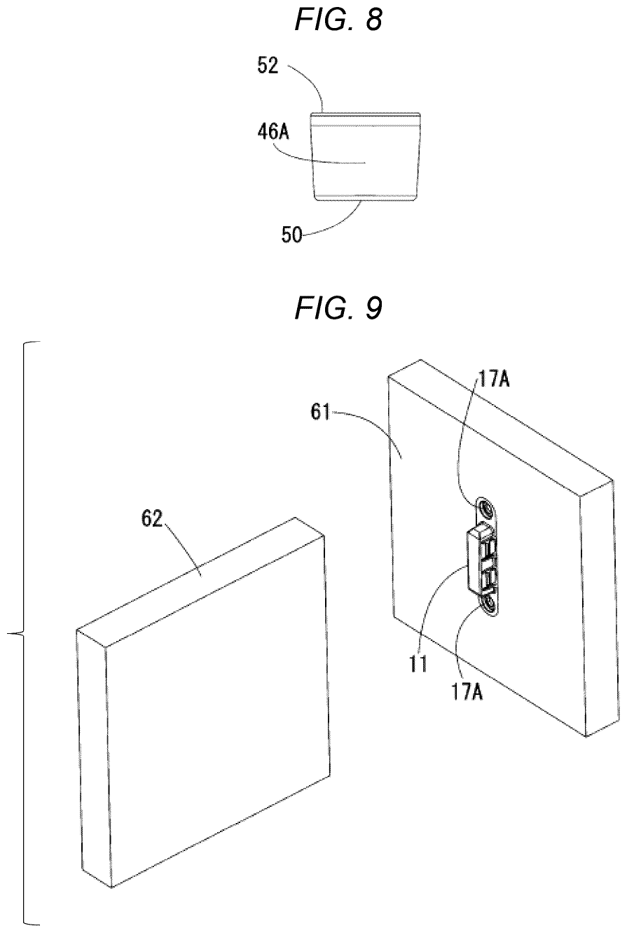

Next, the socket member 41 of the connecting tool 10 will be described. FIG. 5 is a perspective view of the socket member 41, FIG. 6 is a plan view of the socket member 41, FIG. 7 is a front view of the socket member 41, and FIG. 8 is a side view of the socket member 41. In the first embodiment, the socket member 41 includes four openings 42A, 42B, 42C, and 42D. The four openings 42A, 42B, 42C, and 42D are engaged with the four elastic clips 12A, 12B, 12C, and 12D of the plug member 11. The opening 42A and the opening 42B face each other with a bottom plate 50 interposed therebetween. Such a pair of the opening 42A and the opening 42B and another pair of the opening 42C and the opening 42D are arranged side by side in a positional relation such that an intermediate wall portion 44 is interposed therebetween. End sides of the openings 42A to 42D opposite to the intermediate wall portion 44 are connected to side surface portions 46A and 46B having a curved surface shape via end wall portions 45 having a substantially flat plate shape.

The end wall portions 45 and the side surface portions 46A and 46B are integrally structured by a single plate-shaped bottom plate 50, and attachment holes 47A and 47B are provided in the vicinity of the side surface portions 46A and 46B of the bottom plate 50. The socket member 41 is attached to a plate material or the like for use by passing attachment components such as screws through the attachment holes 47A and 47B (see the “first connecting main body 61” and the “second connecting main body 62” illustrated in FIGS. 9 and 10 to be described later). The socket member 41 may be attached to the second connecting main body 62 by adhesion or the like instead of screws, and in this case, it is not necessary to provide the attachment holes 47A and 47B.

A plate-shaped partition wall 51 is provided on one side inside the socket member 41. The partition wall 51 is integrally formed with the bottom plate 50 and the set of end wall portions 45 so as to connect them to each other. The partition wall 51 plays a role of positioning at an initial operation stage when the plug member 11 is inserted into the socket member 41. That is, in the initial operation stage when the plug member 11 is inserted into the socket member 41, an insertion operator first manually positions the plug member 11 such that the insertion-side side surface portion 24B (see FIG. 3) of the plug member 11 is in contact with the partition wall 51 of the socket member 41. The plug member 11 is further inserted into the socket member 41 while maintaining a state in which the insertion-side side surface portion 24B is in contact with the partition wall 51. By performing the insertion operation using the partition wall 51 in this manner, in an operation situation in which the four elastic clips 12A to 12D of the plug member 11 and the four openings 42A to 42D of the socket member 41 cannot be directly viewed, the elastic clips 12A to 12D and the openings 42A to 42D can also be efficiently positioned manually.

Next, a detailed structure of the openings 42A to 42D will be described. As illustrated in FIG. 7, the openings 42A, 42B, 42C, and 42D are inverted U-shaped spaces, and the first step portions 43A to 43D engaged with the claw surfaces 29 on the claw portion engagement side of the claw portions 13A to 13D of the plug member 11 are provided on one side portions of the inverted U-shaped spaces. The second step portions 48A to 48D engaged with the release side inclined surfaces 18A to 18D or the vertical surfaces 19A to 19D of the claw portions 13A to 13D of the plug member 11 are provided in two side portions on both sides of the one side on which the first step portions 43A to 43D are provided. The first step portions 43A to 43D are flat surfaces parallel to the bottom surface 50. That is, when the socket member 41 is placed on a horizontal plane in the state illustrated in FIG. 7, the first step portions 43A to 43D become surfaces substantially parallel to the horizontal plane. In addition, the second step portions 48A to 48D are flat surfaces substantially orthogonal to the bottom surface 50 and also substantially orthogonal to an outer surface of the intermediate wall portion 44 (strictly, for the reason of manufacturing, the flat surfaces are expressed as being substantially orthogonal because the second step portions 48A to 48D are provided with a draft angle of the mold that widens in a direction from the first step portions 43A to 43D toward the bottom surface 50, although the draft angle is minute). Furthermore, as illustrated in FIG. 6, a side (side of a portion different from a portion at which the first step portions 43A to 43D and the second step portions 48A to 48D are present) of the openings 42A to 42D facing a side on which the first step portions 43A to 43D are provided is opened by cutting out a part of the bottom plate 50.

The socket member 41 can be manufactured as an integrally molded product by resin injection, but a mold used in the manufacture of the socket member 41 has a structure advantageous in terms of manufacture in that a shape of each portion is designed so that the socket member 41 can be manufactured only by the mold divided into two upper and lower portions without using a slide core.

Next, a case in which the connecting tool 10 is attached to a component to be originally connected (such as the plate for furniture or the automobile interior component) for use will be described with reference to FIGS. 9 and 10. The plug member 11 and the socket member 41 of the connecting tool 10 are attached to the components to be originally connected (such as the plates for furniture or the automobile interior components) for use, and the components to be originally connected (such as the plate for furniture or the automobile interior components) are referred to as the first connecting main body 61 and the second connecting main body 62 in FIGS. 9 and 10. The embodiment of FIGS. 9 and 10 is an embodiment in which the first connecting main body 61 and the second connecting main body 62 are both rectangular parallelepiped plate-shaped members, and a connecting structure is assembled by connecting these two members in a T-shape. As illustrated in FIG. 9, the plug member 11 is attached to the first connecting main body 61. In order to attach the plug member 11 to the first connecting main body 61, first, a counterbore hole is provided in the first connecting main body 61 so that the attachment portions 16A and 16B of the plug member 11 can be embedded therein. When the first connecting main body 61 is made of wood, a counterbore hole is provided by cutting the first connecting main body 61 in post-processing, and when the first connecting main body 61 is made of resin, the first connecting main body 61 is molded so as to have a counterbore hole in advance. It is important that a depth of the counterbore hole is set such that surfaces 31 (see FIGS. 3 and 4) of the attachment portions 16A and 16B of the plug member 11 and a flat surface of the first connecting main body 61 to which the plug member 11 is attached are substantially the same surface so as not to generate a step in a state in which the plug member 11 is accommodated such that back surfaces 30 (see FIGS. 3 and 4) of the attachment portions 16A and 16B are in contact with bottom surfaces of the counterbore holes. When there is a step between the surfaces 31 of the attachment portions 16A and 16B of the plug member 11 and the flat surface of the first connecting main body 61, a position of the claw portion 13 of the plug member 11 is displaced from a position of the first step portion 43 of the opening 42 on a socket side by a size of the step, and thus it is necessary to pay attention to the depth of the counterbore hole. However, in reality, a machining error may occur when a counterbore hole is provided, and thus in the embodiment of the present invention, the inclination angle α is intentionally provided on the claw surface 29 on the claw portion engagement side of the claw portion 13 to absorb the error.

On the other hand, as illustrated in FIG. 10, the socket member 41 is attached to the second connecting main body 62. The socket member 41 is attached to the second connecting main body 62 in the same manner as described above, and a counterbore hole is provided in the second connecting main body 62 so that the socket member 41 can be embedded therein. In the case of the socket member 41, it is important to position the socket member 41 such that a surface 52 (see FIGS. 7 and 8) when the socket member 41 is attached and a flat surface of the second connecting main body 62 to which the socket member 41 is attached are substantially the same surface without generating a step, and thus a depth of the counterbore hole is set to a depth at which the entire socket member 41 is just embedded.

As described above, the plug member 11 of the first connecting main body 61 and the socket member 41 of the second connecting main body 62 are aligned, whereby the claw surface 29 on the claw portion engagement side engaged in the insertion direction is engaged with the first step portion 43, and the release side inclined surface 18 or the vertical surface 19 engaged in the release slide direction is engaged with the second step portion 48, whereby the first connecting main body 61 and the second connecting main body 62 are connected to each other. In addition, when the engagement between the plug member 11 of the first connecting main body 61 and the socket member 41 of the second connecting main body 62 is released, the plug member 11 is slid with respect to the socket member 41 in a direction toward the release side inclined surface 18 in the release slide direction, thereby releasing the engagement between the release side inclined surface 18 and the second step portion 48, and from this state, the plug member 11 is further pulled out from the socket member 41 in the insertion direction, whereby the plug member 11 is separated from the socket member 41.

Next, a structure in which the plug member 11 and the socket member 41 are connected to each other will be described in more detail with reference to FIGS. 11 and 12. FIG. 11 illustrates a state in which the plug member 11 and the socket member 41 are connected to each other, and the first connecting main body 61 and the second connecting main body 62 are in substantially complete surface contact at contact surfaces 63. FIG. 12 is a cross-sectional view taken along line B-B in FIG. 11. The above-described counterbore holes are provided in the first connecting main body 61 and the second connecting main body 62 so as to have the same shape as the outline of the entire connecting tool 10 in FIG. 11. In order to make the description easy to understand, in FIG. 11, the first connecting main body 61 and the second connecting main body 62 are indicated by oblique lines in a cross section, and the plug member 11 and the socket member 41 are indicated in a front view in a state of being engaged with each other in the counterbore holes of the first connecting main body 61 and the second connecting main body 62.

In the connected state of FIGS. 11 and 12, it is described that a position of the claw surface 29 on the claw portion engagement side of the claw portion 13 of the plug member 11 is a most ideal position with respect to the position of the first step portion 43 of the opening 42 of the socket member 41 (there is no adverse influence such as a machining error of the counterbore hole). As illustrated in FIG. 12, in a state in which the plug member 11 is engaged with the socket member 41, the claw surface 29 on the claw portion engagement side is inclined by the inclination angle α with respect to an engaged surface of the first step portion 43. In the realistic machining state, the machining error may occur in the counterbore holes to be provided in the first connecting main body 61 and the second connecting main body 62. In such a case, when no inclination angle α of the claw surface 29 on the claw portion engagement side in the embodiment of the present invention is provided and this portion is an orthogonal engagement surface (when the angle α is substantially 0 degrees), there is a situation at which the first connecting main body 61 is strongly pushed into but is not engaged with the second connecting main body 62, or conversely, there is a situation at which in the state in which the first connecting main body 61 is engaged with the second connecting main body 62, a gap can also be formed between surfaces on which the first connecting main body 61 and the second connecting main body 62 are to be brought into contact with each other, causing wobbling. However, according to the embodiment of the present invention, in a range (range of a width in the insertion direction in which the inclination angle α is present) to which the inclination angle α of the claw surface 29 on the claw portion engagement side illustrated in FIG. 12 affects, there is an advantage that a top portion of the claw portion 13 can easily take a positional relation of climbing over and being engaged with the first step portion 43, and the gap generated between the contact surfaces of the first connecting main body 61 and the second connecting main body 62 can be absorbed.

Next, a case in which the connection between the plug member 11 and the socket member 41 is released will be described. As described above, one side of the claw portion 13 of the plug member 11 is the release side inclined surface 18, and the other side of the claw portion 13 of the plug member 11 is the vertical surface 19. The engagement of the release side inclined surface 18 and the vertical surface 19 with the second step portion 48 of the opening 42 is advantageous in that the plug member 11 and the socket member 41 can be positioned so as not to cause wobbling not only in the insertion direction but also in the direction orthogonal to the insertion direction (direction of the arrow A in FIG. 11). On the other hand, one side of the claw portion 13 is the inclined surface 18, and thus when the plug member 11 is slid with respect to the socket member 41 with an operation force of a certain amount or more, the release side inclined surfaces 18A to 18D climb over the second step portions 48A to 48D of the openings 42A to 42D and the engagement is released. With such a function, the connection between the first connecting main body 61 and the second connecting main body 62 connected once can be easily released if necessary.

The connecting tool 10 according to the present invention has, in the release slide direction, one side as the release side inclined surface 18 that can be slide-released and the other side as the vertical surface 19 that cannot be slide-released, and thus the connecting tool 10 is also advantageous in that it is possible to suppress the first connecting main body 61 and the second connecting main body 62 from being unintentionally displaced from each other due to gravity by using non-symmetry in the release slide direction. That is, by disposing the vertical surface 19 on a gravity-receiving side of the first connecting main body 61 and the second connecting main body 62 in a gravity-acting direction and disposing the release side inclined surface 18 on a side opposite to the gravity-acting direction, it is possible to suppress the first connecting main body 61 and the second connecting main body 62 from being unintentionally displaced in the release slide direction or unintentionally detached due to the action of the gravity.

In the present invention, an elastic deformation member that is deformed when the plug member 11 and the socket member 41 are engaged with each other is provided not on the socket side but on a plug side, the pair of elastic clips 12A and 12B include the claw portion 13A and the claw portion 13B facing opposite directions, and surfaces on which no claw portion 13A and claw portion 13B are present are disposed in a positional relation of facing inward (positional relation of being back-aligned) so as to sandwich the first wall portion 14 therebetween, and thus it is not necessary to provide an extra space for elastic deformation on the socket side as in the related art disclosed in Patent Literature 1.

In the present invention, the engaged portion on the side that receives the elastic deformation member that is deformed when the plug member 11 and the socket member 41 are engaged with each other is the opening 42 formed by hollowing out a part of the socket member 41, and thus the engaged portion can be designed to be thin and compact by eliminating the need for overlaying as compared with the related art described in Patent Literature 1 in which an engaged portion is formed by overlaying, and there is an advantageous effect that a manufacturing material cost is small. Further, in the present invention, the opening 42 is provided with the second step portion 48 which is engaged not only in the socket insertion direction but also in the direction orthogonal to the socket insertion direction, and thus there is also an advantageous effect that assembly can be performed while positioning in the release slide direction.

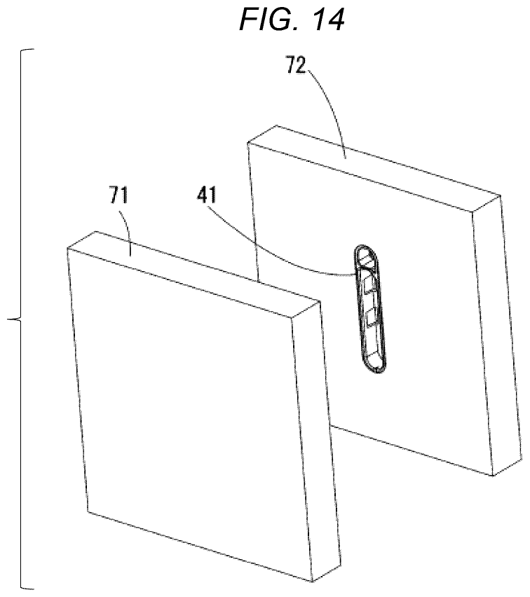

Next, another embodiment of the connecting structure of the connecting tool 10 according to the present invention will be described with reference to FIGS. 13 and 14. The embodiment of the connecting structure illustrated in FIGS. 9 and 10 is an embodiment in which a wide flat surface of the first connecting main body 61 and a narrow flat surface of the second connecting main body 62 having an area and a width smaller than those of the wide flat surface are connected to each other in a T-shape, whereas the embodiment illustrated in FIGS. 13 and 14 is an embodiment in which a wide flat surface of a first connecting main body 71 and a wide flat surface of a second connecting main body 72 having substantially the same area and width as the wide flat surface are connected to each other by surface matching. As illustrated in FIG. 13, the plug member 11 is attached to the first connecting main body 71, and as illustrated in FIG. 14, the socket member 41 is attached to the second connecting main body 72. The plug member 11 and the socket member 41 are attached to the first connecting main body 71 and the second connecting main body 72 in the same manner as described above, and thus the description thereof will be omitted. In this case, it is preferable to dispose the vertical surface 19 of the claw portion 13 of the plug member 11 on the gravity-receiving side.

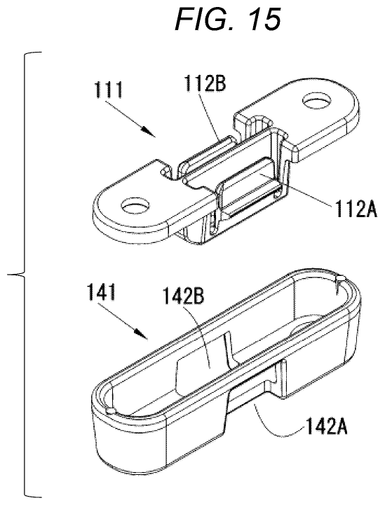

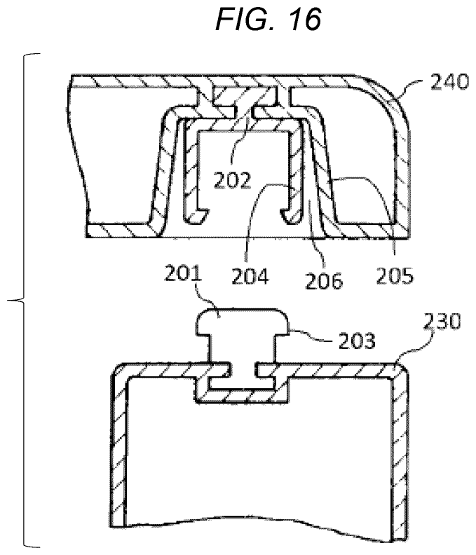

Next, another embodiment of the connecting tool 10 according to the present invention will be described with reference to FIG. 15. The connecting tool 10 described above is an embodiment including two sets of elastic clips 12 (four in total), but the connecting tool 10 of the embodiment illustrated in FIG. 15 includes one set (two in total) of elastic clips 112A and 112B of a plug member 111. Naturally, openings 142A and 142B of a socket member 141 are also one set (two), resulting in a more compact configuration as a whole. This is an embodiment advantageous for connecting a small connecting structure. However, it is not necessarily used only for connecting the small connecting structure, and one elastic clip 112 may be long in accordance with a size of the connecting structure. In the embodiment, no partition wall 51 of the socket member 41 described in the embodiment of FIGS. 5 to 8 is provided, and the socket member 141 has directional symmetry, and thus the plug member 111 can be assembled to the plug member 141 in any direction. The configuration and function relating to the engagement between the elastic clips 112A and 112B and the openings 142A and 142B are the same as those in the above-described embodiment, and further description thereof will be omitted.

As another embodiment, an embodiment may be adopted in which when the connecting structure is further increased in size (or longer), three or more sets of elastic clips 12 may be connected to each other. There is a tendency for the rigidity of the entire plug member 11 to decrease when one elastic clip 12 is designed to be long, and thus from the viewpoint of strength, it is preferable to provide a large number of sets of elastic clips 12 having a length capable of ensuring appropriate rigidity and to provide the second wall portion 15 as shown in the embodiment of FIG. 1 between the elastic clips 12 rather than designing one elastic clip 12 to be long.

The present invention is not limited only to the embodiments disclosed above, and it is also possible to appropriately use techniques recognized by a person of ordinary skill in the art as techniques substantially the same as the technical matters described in the embodiments of the present invention or techniques having the same effects as the technical matters, to use the techniques as alternative techniques, or to additionally add the techniques. Furthermore, it is also possible to recombine and implement characteristic configurations of the above embodiments.

The connecting tool and the connecting structure of the present invention are a more compact and high-performance connecting tool capable of easily connecting and disconnecting components and a connecting structure.

What is claimed is:

1. A connecting tool comprising:
a plug member; and
a socket member, wherein
the plug member includes at least one pair of elastic clips, and the pair of elastic clips each include a claw portion facing an outside of the plug member, and rear surfaces of the elastic clips, which are back sides of surfaces on which the claw portions are present, face inward,
the socket member includes at least one pair of openings configured to be engaged with the elastic clips,
when a direction in which the plug member is to be inserted into the socket member is defined as an insertion direction and a direction orthogonal to the insertion direction is defined as a release slide direction, the claw portion has a claw surface on a claw portion engagement side configured to be engaged in the insertion direction and a release side inclined surface configured to be engaged in the release slide direction, and the opening has a first step portion configured to be engaged with the claw surface on the claw portion engagement side and second step portions configured to be engaged with the release side inclined surface, and
by operating the plug member in the release slide direction with respect to the socket member from a state in which the plug member is engaged with the socket member, an engagement between the release side inclined surface and the second step portions is released, and the plug member is separated from the socket member by further moving the plug member in the insertion direction with respect to the socket member from this state.

2. The connecting tool according to claim 1, wherein
in the state in which the plug member is engaged with the socket member, the claw surface on the claw portion engagement side, which is a surface of the claw portion facing the first step portion, is a surface inclined with respect to an engaged surface of the first step portion.

3. The connecting tool according to claim 1, wherein
the plug member includes a base plate portion to which the elastic clips are to be attached, and a surface of the base plate portion opposite to a surface on which the elastic clips are extended is an insertion-side front surface.

4. The connecting tool according to claim 3, wherein
attachment portions are provided on both sides of the base plate portion of the plug member via insertion-side side surface portions, respectively.

5. The connecting tool according to claim 4, wherein
a partition wall is provided inside the socket member, and the partition wall is a portion in contact with the insertion-side side surface portion of the plug member in an initial operation stage of inserting the plug member into the socket member.

6. The connecting tool according to claim 1, wherein
the openings of the socket member each have an inverted U-shaped space, one side portion of the inverted U-shaped space is the first step portion, two side portions on both sides of the one side portion on which the first step portion is provided are the second step portions, and a side facing the side on which the first step portion is provided is opened.

7. The connecting tool according to claim 1, wherein
one side of the claw portion, which is opposite to another side on which the release side inclined surface is provided, is a vertical surface.

8. The connecting tool according to claim 1, wherein
the plug member includes two or more sets of the elastic clips, and a wall portion is provided between the elastic clips.

9. A connecting structure using the connecting tool according to claim 1, wherein
a first connecting main body is provided with a counterbore hole to which the plug member is to be attached, a second connecting main body is provided with a counterbore hole to which the socket member is to be attached, and the plug member and the socket member are configured to be engaged to connect the first connecting main body and the second connecting main body.

10. The connecting structure according to claim 9, wherein
a flat surface of the first connecting main body to which the plug member is to be attached, and a surface of an attachment portion of the plug member, are substantially the same surfaces, and
a flat surface of the second connecting main body to which the socket member is to be attached, and a surface when the plug member is attached, are substantially the same surface.

11. The connecting structure according to claim 9, wherein
one side opposite to another side on which the release side inclined surface of the claw portion of the plug member is provided is a vertical surface, and in the first connecting main body, the vertical surface of the plug member is disposed on a gravity-receiving side in a gravity-acting direction, and the release side inclined surface of the plug member is disposed on a side opposite to the gravity-receiving side.
